(19) United States
(12) Patent Application Publication
(10) Pub. No.: US 2006/0126517 A1
(43) Pub. Date: Jun. 15, 2006

(54) Loop detection method and device

(75) Inventors: Hiroshi Kurosaki, Yokohama (JP); Sugai Hidenori, Yokohama (JP); Koyanagi Toshinori, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/093,973

(22) Filed: Mar. 30, 2005

(30) Foreign Application Priority Data
Dec. 13, 2004 (JP) 2004-360305

(51) Int. Cl. H04L 12/26; H04L 1/00; H04J 1/16

(52) U.S. Cl. 370/241; 370/229

(57) ABSTRACT

For providing a loop detection method and device which enables a general L2 switch to be applied and complicated condition equations or the like for determining a loop generation, a terminal moving state in which packets of a same transmitting source address are inputted to different ports is detected; a frequency of detecting the terminal moving state is counted for each port; and, when the frequency exceeds a threshold, it is regarded that a loop has occurred at the port.

### BACKGROUND OF THE INVENTION

1. Field of the Invention

The present invention relates to a loop detection method and device, and in particular to a loop detection method and device in a packet transferring L2 switch such as a core switch or an edge switch used for communications over the Internet.

In the prior art L2 switch, a loopless network is structured as a premise, however, a loop may arise due to setting errors or the like, so that the detection of such a loop is demanded.

2. Description of the Related Art

With a recent spread of communications over the Internet, a demand for IP (Internet Protocol) packet communications has been rapidly increased. While such a packet communication is carried out by a packet transfer with an L2 switch or a router, the L2 switch can structure a loopless network by grasping a tree within the network.

For a method grasping a tree within a network, a spanning tree protocol (STP) is generally known, which is a protocol enabling operations between switches existing within the network to be done and a network by an optimum method with an automatic detection and cancellation of the loop to be structured.

While it is known that the generation of a loop can be prevented by using such a spanning tree protocol, it is difficult to accurately grasp an actual configuration at all times in a complicated network. Also, since a loop may occur when a network manager adds a switch to an operating network or turns on a switch which was made off, a mechanism for detecting such a loop state as generated is required.

For a method detecting a loop, is known a technique using EoE (Ether over Ether) capsulating a user packet with an Ethernet (registered trademark) by the L2 switch.

However, such a technique can provide a network structured only with a particular L2 switch supporting EoE. Also, it retains a problem that an overhead with respect to user data is enlarged because of Ether frames further capsulated.

On the other hand, there is proposed a frame relaying apparatus wherein the information and reception time of a frame received are previously registered in a table, a loop generation is determined by the detection of the same frame received twice with reference to the table when the frame is received, and the received frame is discarded without the transmission thereof based on the determination, thereby avoiding the generation of infinite loop (for example, see patent document 1.).

[Patent document 1] Japanese patent application laid open No. 2001-197114

However, this patent document 1 has a disadvantage that a loop generation is determined in case predetermined condition equations are satisfied, in which the condition equations therefor depend on whether or not a packet transferring speed calculated from the received frame and the registered frame exceeds a predetermined maximum packet transferring speed, having an impossible value, so that such a packet transferring speed has to be detected as well.

### SUMMARY OF THE INVENTION

It is accordingly an object of the present invention to provide a loop detection method and device which enables a general L2 switch to be applied and complicated condition equations or the like for determining a loop generation to be excluded.

For the achievement of the above-object, a loop detection method according to the present invention comprises a first step of detecting a terminal moving state in which packets of a same transmitting source address are inputted to different ports; and a second step of counting a frequency of detecting the terminal moving state for each port at the first step and of regarding, when the frequency exceeds a threshold, that a loop has occurred at the port.

Namely, packets of the same transferring source address are normally inputted to the same input port unless the terminal is moved, however, packets of the same transferring source address are inputted to different ports when the terminal is moved.

At the first step, such a terminal moving state is detected, and at the second step, the frequency of the terminal moving state detected per each port at the first step is counted. When the frequency detected exceeds a threshold value, that is, when it is found that the frequency detected indicates such a terminal moving frequency as is normally impossible, it is regarded that a loop is generated at the port.

The principle of the above present invention will now be described referring to drawings.

FIG. 1 shows a normal network example, in which L2 switches 40_1 and 40_2 are mutually connected through a core network 43. The L2 switch 40_1 has ports P0-P2, in which the port P0 is connected to a terminal 41 (MAC address: X), and the L2 switch 40_2 has ports P1-P12, in which the port P10 is connected to a terminal 42 (MAC address: Y).

At first, in the L2 switches 40_1 and 40_2, packet data received at a port are transferred by flooding from the other all ports, and return packet data are sent from a terminal of the destination address of the packet data, whereby the L2 switches 40_1 and 40_2 are to learn the respective learning tables T10 and T11.

After that, when packet data PD1 from the terminal 41 are sent to the port P0 of the L2 switch 40_1, the L2 switch 40_1 retrieves the destination address DA=Y of the packet data PD1, thereby providing as an output the packet data PD1 at the port P1. Namely, the packet data PD1 are transferred from the port P0 to the port P1, and then transmitted to the core network 43.

Then, the packet data PD1 having arrived at the L2 switch 40_2 through the core network 43 are inputted to the port P11. Then the L2 switch 40_2, the learning table T11 has been already prepared so that the data of the destination address DA=Y may be outputted at the port P10, whereby the packet data PD1 are transferred from the port P10 to the terminal 42.

When the terminal 42 having received the packet data PD1 transmits packet data to the terminal 41, packet data PD2 are inputted from the port P10 of the L2 switch 40_2.

Since in the L2 switch 40_2 having received the packet data PD2, the learning table T11 has already learned that the packet data PD1 of the transmitting source address SA=X were inputted at the port P11, the packet data PD2 are transferred from the port P10 to the port P11 and then transmitted to the core network 43.

When the packet data PD2 are transmitted from the core network 43 to the port P1 of the L2 switch 40_1, the learning table T10 in the L2 switch 40_1 indicates the port P0 for the destination address DA=X of the packet data PD2, so that the packet data PD2 are transferred from the port P1 to the port P0, thereby arriving at the terminal 41.

In contrast to such a normal network operation, FIG. 2 shows a network operation example at a time when the ports P1 and P2 in the L2 switch 40_1 have a mutual loop state. In this occasion, the packet data PD1 having inputted at the port P0 of the L2 switch 40_1 are outputted at the port P1 based on a retrieval of the destination address DA=Y by referring to the learning table T10, where the packet data PD1 are inputted to the port P2 as shown since the ports P1 and P2 have the mutual loop state. The packet data PD1 at this time are inputted to the port P2 as above noted and then transferred to the port P1 since the destination address DA=Y indicates the port P1 by referring to the learning table T10. At this time, the transmitting source address SA=X of the packet data PD1 are rewritten into the address of the port P2 at the learning table T10.

Therefore, the L2 switch 40_1 operates as if the terminal 41 moves from the port P0 to the port P2. In such a loop state between the ports P1 and P2, unless the packet data PD1 are inputted at the port P0, the learning table T2 remains unchanged as having been rewritten, so that the packet data PD1 circulate between the ports P1 and P2.

When the packet data PD1 are inputted at the port P0, the learning table T10 is again rewritten so that the transmitting source address SA=X may assume the port P0. Being transferred to the port P1, the packet data PD1 are linked to the port P2, resulting in a repetition of such rewriting.

The terminal movement may arise in an actual operation where a cable of the terminal connected to the network is unplugged from a certain port and reconnected to another port, which can not occur frequently so much.

Therefore, when the terminal moving frequency counted per each port is compared with a threshold and exceeds it, an abnormal state, i.e. a loop state that does not provide a supposed terminal movement can be detected.

Considering the operation of this case where a loop is formed over the network, the packet data transferred from a device having relayed the packet data are folded back, so that the packet data folded back can be regarded as a terminal movement except a case where the packet data are inputted at the same port. Therefore, in the loop state formal, the packet data are looped within the network, which means a similar operation to a serial occurrence of terminal movement, so that the terminal movement can be frequently counted, as compared with a frequency of the terminal movement generated in an actual operation. By taking advantage of this, such an abnormal state can be detected as a loop state.

It is to be noted that the first step may include a third step of learning a relationship between transmitting source addresses of packets and ports, to be held in a table, and a fourth step of detecting, after learning at the third step, the terminal moving state where a port to which a packet is inputted is different from a port retrieved from the table for a same address as a transmitting source address of the inputted packet.

Also, the threshold may comprise a value exceeding a frequency regarded as a moving frequency of a terminal for the port.

Also, this loop detection method may further comprise a fifth step of masking the port where the loop has occurred when the second step regards that the loop has occurred.

Also, the first step may further include a step of determining to which card the port belongs for detecting the terminal moving state.

Namely, not only a loop state between ports in a single card but also a loop state between ports across a plurality of cards, i.e. a loop state generated in which port of which card can be detected.

Also, the first step may further include a step of flooding on condition that no packet is outputted outside when the terminal moving state is detected.

Namely, such a terminal movement state should not be informed to an external network or the like but should only have to be flooded inside.

Also, the learned table may include a destination address of a packet, and the first step may further include a step of flooding the packet when a destination address of the input packet is not included in the table, and of unicasting the input packet when the destination address is included in the table.

A loop detection device according to the present invention which realizes the above loop detection method comprises first means detecting a terminal moving state in which packets of a same transmitting source address are inputted to different ports; and second means counting a frequency of detecting the terminal moving state for each port at the first means and regarding, when the frequency exceeds a threshold, that a loop has occurred at the port.

Also, the first means may include third means learning a relationship between transmitting source addresses of packets and ports, to be held in a table, and fourth means detecting, after learning at the third means, the terminal moving state where a port to which a packet is inputted is different from a port retrieved from the table for a same address as a transmitting source address of the inputted packet.

Also, the threshold may comprise a value exceeding a frequency regarded as a moving frequency of a terminal for the port.

Also, this loop detection device may further comprise fifth means masking the port where the loop has occurred when the second means regards that the loop has occurred.

Also, the first means may further include means determining to which card the port belongs for detecting the terminal moving state.

Also, the first means may further include means flooding on condition that no packet is outputted outside when the terminal moving state is detected.

Also, the learned table may include a destination address of a packet, and the first means may further include means flooding the packet when a destination address of the input packet is not included in the table, and unicasting the input packet when the destination address is included in the table.

According to a loop detection method and device of the present invention, an abnormal state can be detected with a general L2 switch and a loop determination can be made, so that without being limited to a particular network capsulated with an Ether frame, a congestion state due to such a loop within a general network can be detected and avoided.

### BRIEF DESCRIPTION OF THE DRAWINGS

The above and other objects and advantages of the invention will be apparent upon consideration of the following detailed description, taken in conjunction with the involving drawings, in which the reference numerals refer to like parts throughout and in which:

FIG. 1 is a block diagram showing a normal network example for explaining the principle of the present invention;

FIG. 2 is a block diagram showing a network example upon occurrence of a loop for explaining the principle of the present invention;

FIG. 3 is a block diagram showing a schematic arrangement of a device such as an L2 switch for realizing a loop detection method according to the present invention;

FIG. 4 is a block diagram showing an embodiment arrangement of a card in an L2 switch shown in FIG. 3;

FIG. 5 is a chart showing an arrangement of a learning table used in the present invention;

FIG. 6 is an operation summary chart of a loop detection method and device according to the present invention;

FIGS. 7A and 7B are learning table charts showing an initial state before reception of packet data in a loop detection method and device according to the present invention;

FIGS. 8A and 8B are learning table charts after having received packet data PD1;

FIGS. 9A and 9B are learning table charts after having received packet data PD2;

FIGS. 10A and 10B are learning table charts after having received packet data PD3; and

FIGS. 11A and 11B are learning table charts after having received packet data PD4.

### DESCRIPTION OF THE EMBODIMENTS

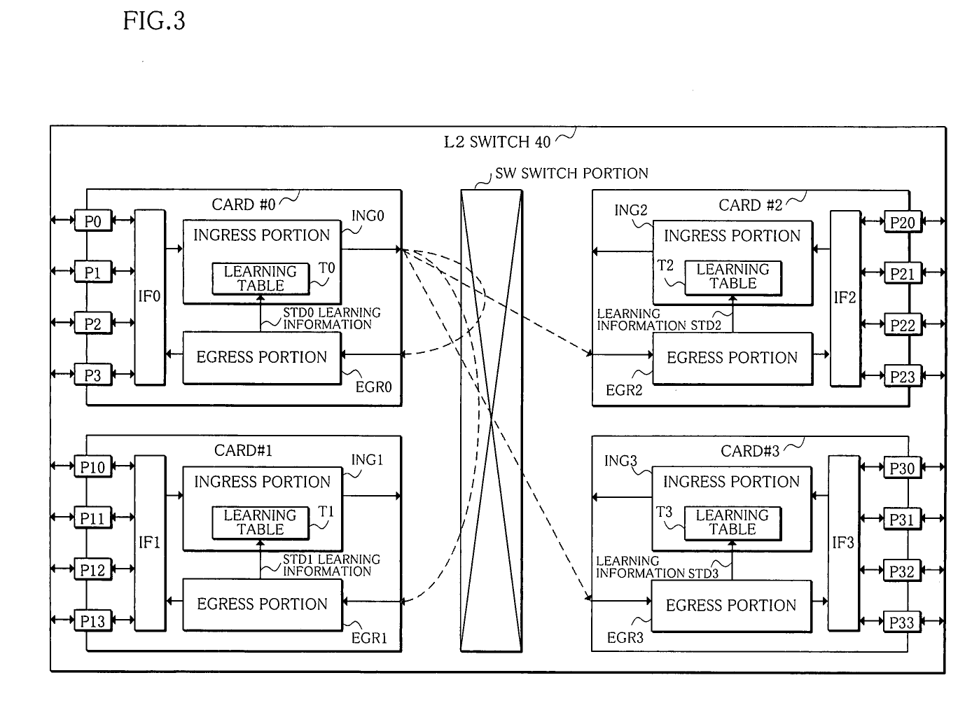

FIG. 3 shows a schematic arrangement of a device which realizes a loop detection method according to the present invention, in which the loop detection device of this embodiment employs an L2 switch 40. This L2 switch 40 is composed of, for example, for cards #0-#3 and a switch portion SW mutually connecting these cards.

The cards #0-#3 are respectively formed of ports P0-P3, P10-Pl3, P20-P23, P30-P33, interface portions IF0-IF3, Ingress portions ING0-ING3, and Egress portions EGR0-EGR3. The Ingress portions ING0-ING3 have learning tables T0-T3. The Ingress portions ING0-ING3 and the Egress portions EGR0-EGR3 are mutually connected through the switch portion SW. The learning tables T0-T3 are provided respectively with learning information STD0-STD3 from the Egress portions EGR0-EGR3.

In this arrangement, packet data inputted from one of the ports P0-P3 of the card #0 for example are transferred to the switch portion SW by retrieving the learning table T0 based on the destination address (DA) of the packet data and obtaining the information of a card and a port transferring the packet data. Upon transferring the packet data, a card No. and a port No. connected to a destination terminal are attached or added to the packet data.

If the destination address is not registered in the learning table T10, the Ingress portion ING0 transfers (floods) the packet data inputted through the switch portion SW to the Egress portions EGR0-EGR3 of all of the cards #0-#3 within the L2 switch 40. Also in this case, the destination card No. and the port No. are added to the packet data.

The Egress portions EGR0-EGR3 extract the source address (SA), card No. and the port No. from the packet data including the card No. and the port No. received from the switch portion SW, and transfer them as learning information STD0 to the learning table T0 in the Ingress portion ING0. The learning information STD0 registered indicates under which port of which card the transferring source address SA exists, forming destination information of the packet data obtained at the time of retrieving the learning table T0 by the destination address DA.

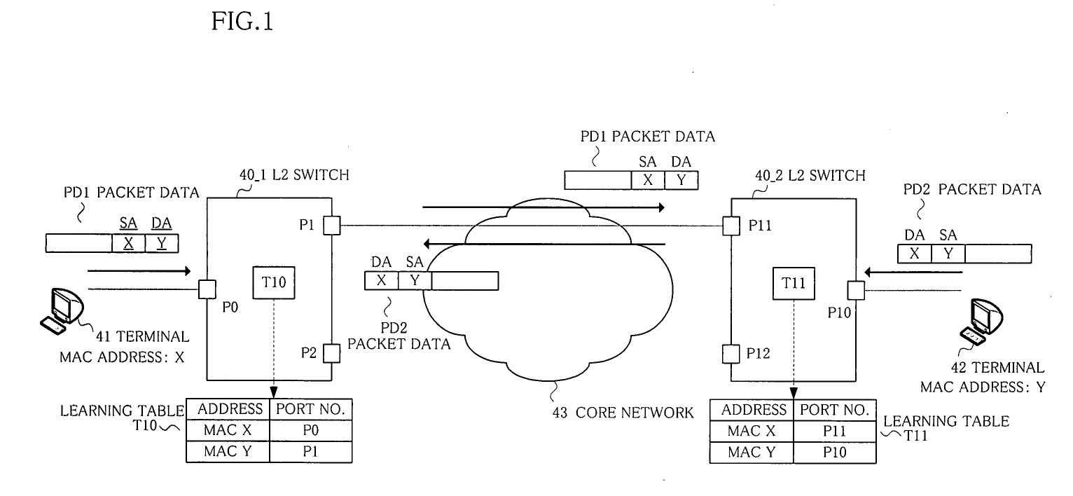

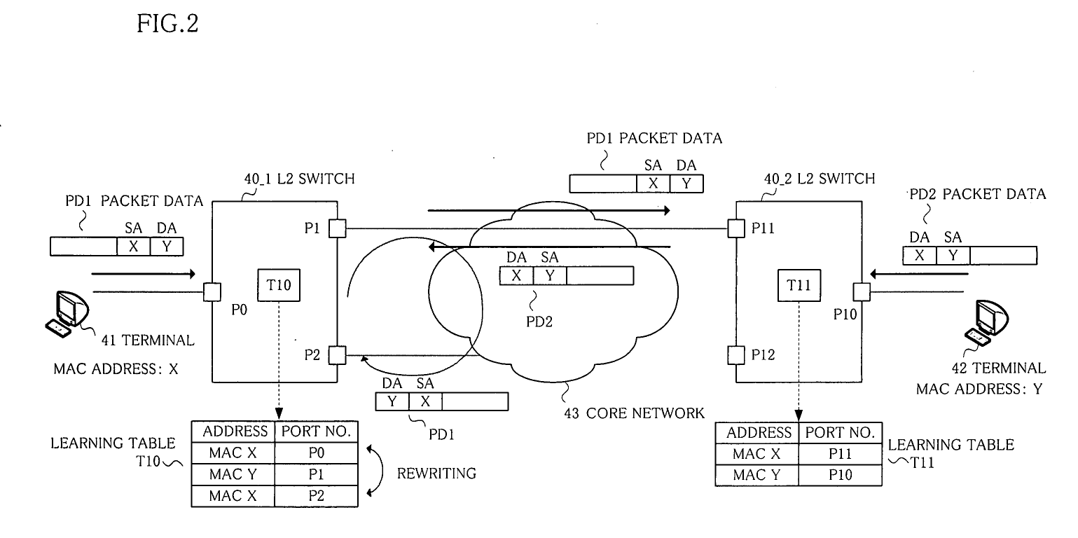

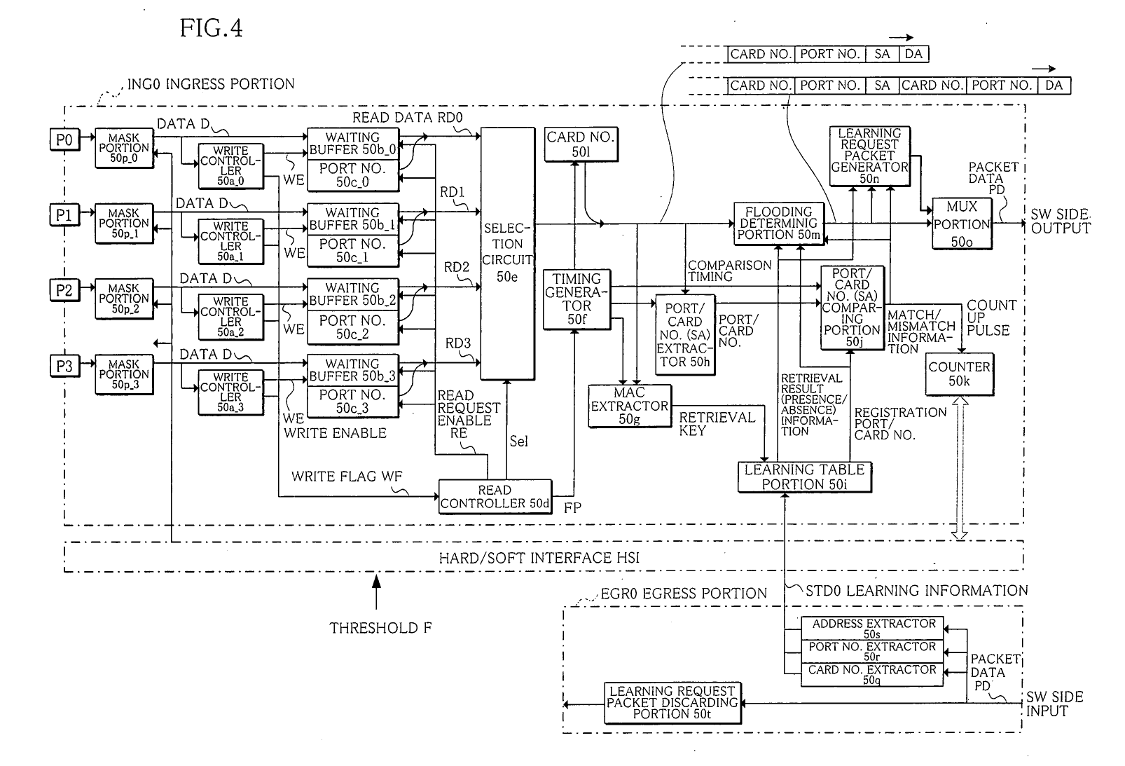

FIG. 4 shows an arrangement of each embodiment of the cards #0-#3 in the L2 switch 40 shown in FIG. 3, in which an arrangement of the card #0 shown in FIG. 1 is particularly illustrated.

In this arrangement, the ports P0-P3 are respectively connected to write controllers 50a_0-50a_3 (hereinafter, occasionally represented by 50a) through mask portions 50p_0-50p_3 (hereinafter, occasionally represented by 50p), and to waiting buffers 50b_0-50b_3 (hereinafter, occasionally represented by 50b). This makes the packet data, inputted into any one of the ports P0-P3, written in either of the waiting buffers 50b through the mask portions 50p. It is to be noted that the mask portions 50p are controlled by a hard/soft interface HSI, being initially set to be unmasked.

The waiting buffers 50b are provided with a write enable signal WE from the write controllers 50a. When the packet data are written in the waiting buffers 50b, a write complete flag WF indicating whether or not the waiting buffers 50b are empty is provided to a read controller 50d from the write controllers 50a.

The read controller 50d monitors the capacity of the waiting buffers 50b from the received write complete flag WF, and provides a read enable signal RE to the waiting buffers 50b when there are packet data within the buffers 50b, thereby reading from the waiting buffers 50b the packet data which are then transmitted to a selection circuit 50e as read data RD0-RD3 added with port Nos. stored in port No. storages 50c_0-50c_3 (hereinafter, occasionally represented by 50c).

By receiving a selection signal Sel generated from the read controller 50d in response to the write complete flag WF, the selection circuit 50e selects and outputs any one of the read data RD0-RD3 from a port presently in reception.

Also from the read controller 50d, a frame pulse FP indicating the head of the packet data is provided to a timing generator 50f. To this timing generator 50f, a MAC address (destination address/source address) extractor 50g, a port/card No. extractor 50h, a port/card No. comparing portion 50j, and a card No. storage 501 are connected, each of these components being provided with a timing signal. The packet data outputted from the selection circuit 50e are provided to the MAC address extractor 50g, the port/card No. extractor 50h, and a flooding determining portion 50m.

The MAC address extractor 50g extracts and holds the MAC address (destination address and source address) within the packet data based on a timing generated by the timing generator 50f. The MAC address held is provided to a learning table 50i as a retrieval key.

The learning table portion 50i corresponds to the learning table T0 shown in FIG. 3, is retrieved based on the MAC address received, outputs the port No. and the card No. registered for the MAC address to the port/card No. comparing portion 50j and the flooding determining portion 50m, and besides the retrieval result (presence/absence) to the flooding determining portion 50m.

The port/card No. extractor 50h extracts the port No. and the card No. added to the packet data from the head signal received, and transmits them to the port/card No. comparing portion 50j. This port/card No. comparing portion 50j compares the port No. and the card No. held at the port/card No. extractor 50j with the port/card No. already retrieved in the learning table 50i, based on the timing (comparing timing) generated by the timing generator 50f, incrementing the count of a counter 50k with a counting pulse in case of inconsistency as a result of comparison.

The hard/soft interface HSI performs polling the counter 50k at a fixed interval, and reads the count (number of terminal movement) per each port to be aggregated with a software. When the aggregated count exceeds a predetermined threshold F during a fixed term, a loop detection for the object port is found, and masking is performed for the mask portions 50p with respect to the object port of the card having a loop detected, thereby suppressing the transfer of the packet data.

The card No. storage 501 stores a proper card No. of the cared #0, which is provided to the flooding determining portion 50m together with the packet data from the selection circuit 50e in response to the timing signal from the timing generator 50f. Therefore, the header of the input packet data to the flooding determining portion 50m assumes, as shown, “DA/SA/port No. of SA/card No. of SA”.

The flooding determining portion 50m, in response to the retrieval result (presence/absence information) from the learning table 50i and the port/card No. retrieved from the learning table 50i as well as the inconsistency information from the port/card No. comparing portion 50j, provides the output packet (flooding packet or unicast packet) to a learning request packet generator 50n and a multiplexer (MUX) 50o.

The learning request packet generator 50n is adapted to receive the retrieval result of the learning table 50i and the inconsistency information from the port/card No. comparing portion 50j, and generates the learning request packet to be transmitted to the multiplexer 50o. The packet data added with the port No. and the card No. from the multiplexer 50o are transferred to the switch portion SW shown in FIG. 3.

The packet data inputted through the switch portion SW are transmitted to all of the Egress portions EGR0-EGR3 or any one of them. The learning information STD0 is stored in the learning table 50i through a card No. extractor 50q, a port No. extractor 50r, and an address extractor 50s. The learning table 50i performs the retrieval within the learning table 50i and performs an arbitration of the learning registration upon reception of the learning information to register the port No. and the card No. for the MAC address information.

Also, the Egress portion EGR0-EGR3 respectively comprise a learning request packet discarding portion 50t, in which only when the packet data from the switch portion SW are learning request packets, the packets are discarded while otherwise they are passed therethrough.

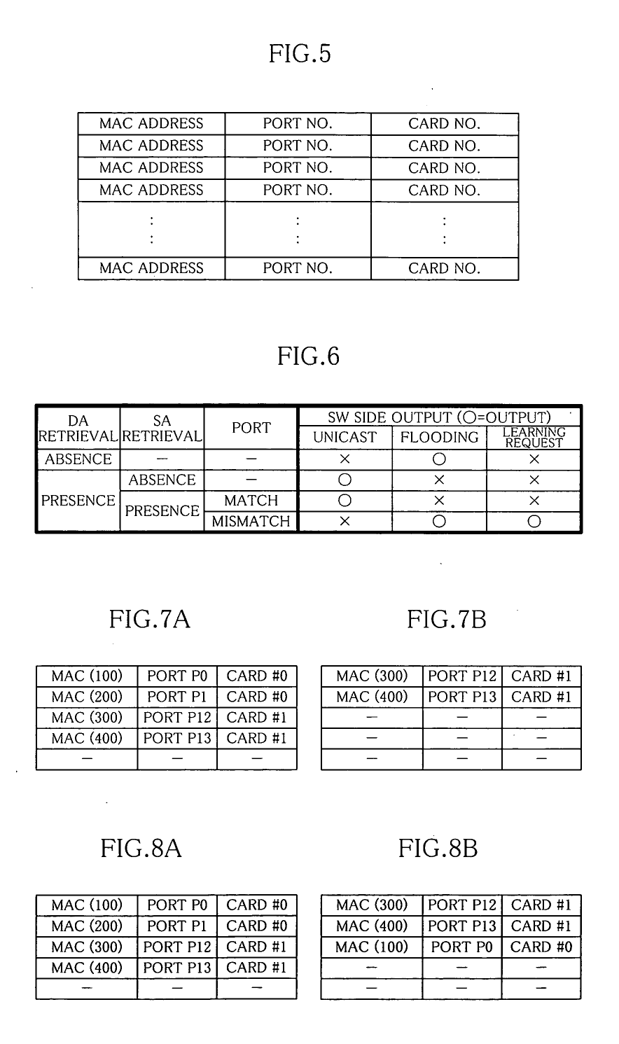

FIG. 5 shows an arrangement of the learning table 50i, in which a CAM can be used as one example of the learning table divided into three items. The first item indicates a MAC address (destination address/source address), the next item indicates a port No, and the third item indicates a card No. It is to be noted that the address is not limited to MAC address but various modified addresses can be used.

Hereinafter, the operation of the embodiment shown in FIG. 4 will be described by referring to an output operation summary of output packets shown in FIGS. 3 and 6 and learning table examples shown in FIGS. 7-11. It is to be noted that taking only the cards #0 and #1 shown in FIG. 3 as an example, packet data are supposed to be inputted to the card #0. The learning tables in the cards #0 and #1 are updated or renewed each time packet data are received.

Initial State (Before Reception of Packet Data PD1-PD4); Learning Table in FIG. 7

It is now supposed that the learning table in the card #0 has a table state as shown in FIG. 7A and that the card #1 has a table state as shown in FIG. 7B. This is obtained by the result of flooding and learning as having been described referring to FIG. 1.

Operation After Reception of Packet Data PD1 (DA=300; SA=100; Port P0); Learning Table in FIG. 8

In an initial state of the learning table 50i (T0) shown in FIGS. 7A and 7B, when the packet data PD1 (DA=300; SA=100) are inputted at the port P0, the packet data PD1 are written in the corresponding waiting buffer 50b under the control of the write controller 50a. The write controller 50a transfers the write complete flag WF to the read controller 50d after the write completion. The read controller 50d performs a read control to the write controller 50a and the port No. storages 50c, and a selection control to the selection circuit 50e. By the selection circuit 50e and the card No. storage 501, packet data (DA/SA/port P0/card #0) attached with information for learning are prepared (see a frame in FIG. 4) and transferred to the flooding determining portion 50m.

Thereafter, the MAC address is extracted at the MAC address extractor 50g, and the retrieval of the destination address DA=300 is carried out to the learning table 50i, thereby obtaining “port P12/card #1” from the learning table 50i of the card #0 shown in FIG. 7A. This indicates that destination information is stored in the learning table 50i, so that in the operation summary shown in FIG. 6, the DA retrieval result is found “present” (hit), which is provided to the flooding determining portion 50m.

Since in the flooding determining portion 50m, the DA retrieval result is found “present” and the SA retrieval result is found “present” and inconsistency between input ports has not yet been detected, packet data (DA/port P12/card #1/SA/port P0/card #0) in which packet data from the selection circuit 50e and the card No. storage 501 are added with “port P12/card #1” of the destination address DA are transferred to the multiplexer 50o (see another frame in FIG. 4). The multiplexer 50o then transmits in a unicast mode the packet data PD1 to the port P12 of the card #1 through the switch portion SW.

In the card # 1, the Egress portion EGRL receives the packet data PD1 from the switch portion SW. The packet data PD1 pass through the learning request packet discarding portion 50t in the Egress portion EGRL without any change, and are outputted to a corresponding terminal through the interface portion IFI and the port P12.

In the Egress portion EGRL of the card #1, the packet data are provided to the card No. extractor 50q, the port No. extractor 50r, and the address extractor 50s, in which the card No., the port No., and the address are respectively extracted and transferred to the learning table 50i.

In this learning table 50i (learning table T1 in FIG. 3) of the card #1 shown in FIG. 7B, the source address (SA=100) of the packet data PD1 is not stored, so that as shown in FIG. 8B by a hatched portion, it is learned and then stored that the port P0 of the card #0 is connected to the terminal of the source address SA=100.

On the other hand, in the card #0, the port/card No. extractor 50h extracts the port No. (50c) and the card No. (501) for the source address attached to the packet data PD1 to be transferred to the port/card No. comparing portion 50j. In the port/card No. comparing portion 50j, the port/card No. extracted at the port/card No. extractor 50h is compared with the port/card No. retrieved from the learning table 50i based on the source address SA extracted by the MAC address extractor 50g.

As a result, the MAC address of the port P0 in the card #0 before receiving the packet data PD1 shown in FIG. 7A is “100”, that is the same as the MAC address=100 of the port P0 in the card #0 after reception of the packet data PD1 shown in FIG. 8A, so that the consistency between them is detected. In the case of consistency, no count-up pulse is outputted to the counter 50k.

Thus, the learning tables in the cards #0 and #1 are registered as shown in FIGS. 8A and 8B.

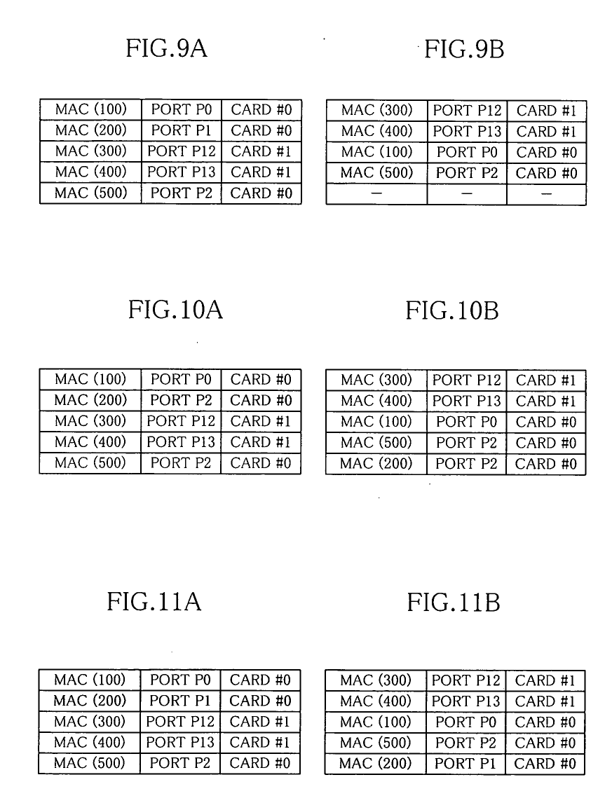

Operation After Reception of Packet Data PD2 (DA=600; SA=500; Port P2): Learning Table in FIG. 9

When the packet data PD2 (DA=600; SA=500) are inputted from the port P2 of the card #0, packet data are prepared in the same manner as the case of the above noted packet data PD1, the MAC address is extracted at the MAC address extractor 50g, and acquisition of the destination address and confirmation of transferring source address for the learning table 50i are performed.

In this case, because the destination address DA=600, the card #0 has no item corresponding to the address “600” and can not acquire the destination address as shown in FIG. 9A, with the result that a signal indicating a retrieval result found “absent” (mishit) is provided to the flooding determining portion 50m from the learning table 50i. This makes the flooding determining portion 50m output the prepared packet data added with a flooding identifier to the switching portion SW through the multiplexer 50o, as shown in FIG. 6. This enables the switching portion SW to perform flooding transfer to all of the cards and ports.

Upon retrieving the source address SA at the MAC address extractor 50g, the source address SA=500 is not retrieved with regard to the card #0 shown in FIG. 8A, so that no comparison is performed at the port/card No. comparing portion 50j and therefore no count-up pulse is provided to the counter 50k.

The packet data transferred to all of the cards and ports are extracted with “source address SA=500/port P2/card #0” in each card, and transferred as the learning information STD to the learning table 50i, so that as shown in FIGS. 9A and 9B by hatched portions, they are registered in a learning mode.

Operation After Reception of Packet Data PD3 (DA=400; SA=200; Port P2): Learning Table in FIG. 10

When the packet data PD3 (DA=400; SA=200) are inputted from the port P2 of the card #0, packet data are prepared as in the above, so that acquisition of destination information and confirmation of source address are performed to the learning table 50i in the order of destination address DA and the source address SA. In this case, based on the state in FIG. 9A, “port P13/card #1” is acquired as the source address SA=200.

As in the above, since a retrieval result found “present” is provided to the flooding determining portion 50m from the learning table 50i, the flooding determining portion 50m attaches “port P13/card #1” to the destination address DA in the inputted packet data PD3.

This makes the flooding determining portion 50m transfer the packet data PD3 to the learning request packet generator 50n and the multiplexer 50o. At this time, the retrieval result found “present” outputted from the learning table 50i is also transferred to the learning request packet generator 50n.

On the other hand, when the port/card No. extractor 50h extracts the port No. and the card No. regarding the source address attached to the packet data to be transmitted to the port/card No. comparing portion 50j, in which “port P1/card #0” from the source address SA has been provided from the learning table 50i, so that inconsistency is detected because “port P2/card #0 (output of the extractor 50h)≠“port P1/card #0” (output of the learning table 50i).

Upon such an inconsistency detection, the port/card No. comparing portion 50j provides a count-up pulse to the counter 50k regarding that the terminal movement has occurred, so that the counter 50k increments its built-in counter in response to the count-up pulse.

On the other hand, the learning request packet generator 50n has received the information of retrieval result found “present” from the learning table 50i and inconsistency information from the port/card No. comparing portion 50j. As a result, as shown in FIG. 6, DA retrieval=“present”, SA retrieval=“present”, and the comparison result by the port/card No. comparing portion 50j is found “inconsistent”, so that the learning request packet is prepared and transferred to the multiplexer 50o. At this time, the learning request packet generator 50n operates to add thereto a learning packet identifier.

Resultantly, this learning request packet is transferred to all of the cards #0-#3. Since such a flooding operation is not required to be done in the outside of the L2 switch 40, the learning request packet discarding portion 50t in each of the Egress portions EGR having received the learning request packet is to discard the learning request packet.

Consequently, as shown in FIG. 10A by a hatched portion, the source address “port P2/card #0” is to be learned and registered in each of the cards #0-#3 of the L2 switch 40 shown in FIG. 3.

Operation After Reception of Packet Data PD4 (DA=400; SA=200; port P1): Learning Table in FIG. 11

When packet data PD4 (DA=400; SA=200) are inputted from the port P1 of the card #0, packet data are prepared in the same manner as the above, the MAC address extractor 50g extracts the MAC address, and the acquisition of destination information and the confirmation of source address are performed to the learning table 50i in the order of the destination address DA and the source address SA. In this case, the packet data PD4 acquires “port P13/card #1” as the destination information and “port P2/card #0” as the source address SA.

According to the destination address DA thus obtained, as in the above, the packet data PD4 are transmitted in a unicast mode toward the port P13 of the card #1.

On the other hand, the port/card No. extractor 50h extracts the port No. and the card No. attached to the packet data PD4, and the port/card No. comparing portion 50j compares the port/card No. extracted from the packet data PD4 with the port/card No. retrieved from the learning table 50i. As a result, since “port P1/card #0” (output of the extractor 50h) # “port P2/card #0” (output of the learning table 50i), inconsistency is detected.

This inconsistency detection makes the counter 50k generate a counter pulse, regarding that the terminal movement state has occurred, so that the counter 50k increments the counter in response to the counter pulse.

Also in the same manner as the packet data PD3 shown in FIG. 11, the learning request packet generator 50n performs flooding with addition of the learning request packet identifier based on the operation summary shown in FIG. 6 since DA retrieval=“present”, SA retrieval=“present”, and comparison result of port/card No.=“inconsistency”.

Consequently, as shown in FIG. 1A, the card #0 has learned “port P1/card #0” to be updated with reference to the MAC address=200. This also applies to the card #1.

Thus, the states in FIGS. 10 and 11 indicate that the ports P1 and P2 in the card #0 are in terminal moving states. If the packet data PD3 and PD4 are alternatively inputted from the ports P1 and P2, the inconsistency of the port/card No. is detected every time the packet is inputted, and a count-up pulse is generated to increment the counter 50k, so that the count of the counter 50k is read by polling from the hard/soft interface HSI and the counting is performed per each port. When the count exceeds for example 100 times/sec. (for a certain fixed interval), it is found that a terminal movement is not a simply movement but a loop is generated between the ports P1 and P2 in the card #0.

In the case of loop state, the hard/soft interface HSI masks the mask portions 50p with a software to suppress transferring data of a port to be looped.

It is to be noted in this operation example that since the packet data PD1-PD4 arriving at the card #0 acquire destination information and source information from the learning table to detect a terminal movement in case of inconsistency between pieces of source address information, and the learning table is updated when the terminal movement has occurred, flooding is performed for the corresponding packet. As a result, port/card information after the terminal movement is to be learned in the learning table, so that it becomes possible to detect a terminal movement at a time of next packet arrival.

Also, in a state where the network raises a loop such as continuously causing a state where packets of the same source address are inputted from a plurality of ports/cards, it is found that an abnormal state where a terminal movement continuously occurs can be detected.

1. A loop detection method comprising:
a first step of detecting a terminal moving state in which packets of a same transmitting source address are inputted to different ports; and
a second step of counting a frequency of detecting the terminal moving state for each port at the first step and of regarding, when the frequency exceeds a threshold, that a loop has occurred at the port.

2. The loop detection method as claimed in claim 1, wherein the first step includes a third step of learning a relationship between transmitting source addresses of packets and ports, to be held in a table, and a fourth step of detecting, after learning at the third step, the terminal moving state where a port to which a packet is inputted is different from a port retrieved from the table for a same address as a transmitting source address of the inputted packet.

3. The loop detection method as claimed in claim 1, wherein the threshold comprises a value exceeding a frequency regarded as a moving frequency of a terminal for the port.

4. The loop detection method as claimed in claim 1, further comprising a fifth step of masking the port where the loop has occurred when the second step regards that the loop has occurred.

5. The loop detection method as claimed in claim 1, wherein the first step further includes a step of determining to which card the port belongs for detecting the terminal moving state.

6. The loop detection method as claimed in claim 1, wherein the first step further includes a step of flooding on condition that no packet is outputted outside when the terminal moving state is detected.

7. The loop detection method as claimed in claim 2, wherein the learned table includes a destination address of a packet, and the first step further includes a step of flooding the packet when a destination address of the input packet is not included in the table, and of unicasting the input packet when the destination address is included in the table.

8. A loop detection device comprising:
first means detecting a terminal moving state in which packets of a same transmitting source address are inputted to different ports; and
second means counting a frequency of detecting the terminal moving state for each port at the first means and regarding, when the frequency exceeds a threshold, that a loop has occurred at the port.

9. The loop detection device as claimed in claim 8, wherein the first means include third means learning a relationship between transmitting source addresses of packets and ports, to be held in a table, and fourth means detecting, after learning at the third means, the terminal moving state where a port to which a packet is inputted is different from a port retrieved from the table for a same address as a transmitting source address of the inputted packet.

10. The loop detection device as claimed in claim 8, wherein the threshold comprises a value exceeding a frequency regarded as a moving frequency of a terminal for the port.

11. The loop detection device as claimed in claim 8, further comprising fifth means masking the port where the loop has occurred when the second means regards that the loop has occurred.

12. The loop detection device as claimed in claim 8, wherein the first means further include means determining to which card the port belongs for detecting the terminal moving state.

13. The loop detection device as claimed in claim 8 or 9, wherein the first means further include means flooding on condition that no packet is outputted outside when the terminal moving state is detected.

14. The loop detection device as claimed in claim 9, wherein the learned table includes a destination address of a packet, and the first means further include means flooding the packet when a destination address of the input packet is not included in the table, and unicasting the input packet when the destination address is included in the table.
